(19) United States
(12) Patent Application Publication
(10) Pub. No.: US 2017/0263395 A1
(43) Pub. Date: Sep. 14, 2017

(54) Switch Cell Apparatus having a Non-Electrical Tactile Feedback Pad

(71) Applicant: Alexandru Salagean, Mississauga (CA)

(72) Inventor: Alexandru Salagean, Mississauga (CA)

(73) Assignee: Omron Automotive Electronics Co., Ltd., Aichi (JP)

(21) Appl. No.: 15/066,579

(22) Filed: Mar. 10, 2016

(51) Int. Cl. H01H 25/04; H01H 9/04

(52) U.S. Cl. CPC H01H 25/04; H01H 9/04; H01H 2215/004; H01H 2215/028

(57) ABSTRACT

Embodiments of the present invention provide switch cells that use a non-electrical tactile feedback pad to adjust the tactile feel of the included switches. As a non-limiting advantage, separating the tactile feedback pad from the electrical switching operation allows the electrical contacts to be configured for high-current applications while relying on the tactile feedback pad to define or “tune” the tactile feel of the switch cell. Moreover, the same switch cell design may be used to meet a variety of tactile feel requirements, simply by installing different tactile feedback pads. That is, the same switch cell can be reconfigured to have a different tactile response curve simply by changing out the tactile feedback pad(s) used in the switch cell, without affecting the electrical characteristics of the switch cell.

### TECHNICAL FIELD

The present invention relates to switch cells and particularly relates to a switch cell apparatus having a non-electrical tactile feedback pad.

### BACKGROUND

Automobiles represent a prime, but not an exclusive, example of the burgeoning market for electrical switches. A typical power seat in a modern automobile has multiple switches associated with it, e.g., one or more switch cells for adjusting forward/aft position, seat angle, lumbar support settings, etc. The tactile feel of the switches integrated into these switch cells represents a critical element of the “user experience.” Consequently, vehicle manufacturers, or the Original Equipment Manufacturers (OEMs) that supply them, often specify particular tactile curves for different switches, or for different switch functions, and for different switch applications, e.g., luxury or high-end applications versus economy or basic applications.

Switch cell manufacturers face significant challenges in controlling the number of switch designs needed to satisfy the varied and changing tactile feel requirements. Further complications arise in meeting the electrical requirements applicable to at least some types of switch cells. For example, so-called dome switches use a collapsible rubber dome or “pillow” as a movable switch contact, where the underside of the dome includes a carbon pad or other conductive material.

However, dome switches are, in general, not suitable for use in high current applications, such as where the switch cell will be used to switch current to the motors used for power seat adjustment. High-current switches commonly use “hard” switch contacts, i.e., sets of metallic contacts. While metallic switch contacts are well suited for switching the high currents associated with power seat motors, they tend to be loud and setting or controlling their tactile feel is challenging.

### SUMMARY

Embodiments of the present invention provide switch cells that use a non-electrical tactile feedback pad to adjust the tactile feel of the included switches. As a non-limiting advantage, separating the tactile feedback pad from the electrical switching operation allows the electrical contacts to be configured for high-current applications while relying on the tactile feedback pad to define or “tune” the tactile feel of the switch cell. Moreover, the same switch cell design may be used to meet a variety of tactile feel requirements, simply by installing different tactile feedback pads. That is, the same switch cell can be reconfigured to have a different tactile response curve simply by changing out the tactile feedback pad(s) used in the switch cell, without affecting the electrical characteristics of the switch cell.

According to some embodiments, a switch cell includes a housing assembly and a switch comprising first and second electrical contacts configured as a contact pair and supported within the housing assembly. The switch cell also includes a non-electrical tactile feedback pad separate from the switch and supported within the housing assembly. The tactile feedback pad has a configured compression force profile for imparting a desired tactile curve associated with actuation of the switch via an actuator assembly that is movably supported within the housing assembly. The actuator assembly comprises a first member extending to an exterior of the housing assembly and coupled to one or more interior members that are configured to actuate the switch while simultaneously compressing the tactile feedback pad when the first member is moved in a defined switch actuation direction.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a perspective view of one embodiment of a switch cell.

FIG. 2 is an electrical schematic of the switch cell of FIG. 1.

FIG. 3 is a cutaway perspective view of one embodiment of a switch cell.

FIGS. 4 and 5 are exploded views of example embodiments of a switch cell.

FIGS. 6 and 7 are diagrams of example tactile curves for a switch cell.

### DETAILED DESCRIPTION

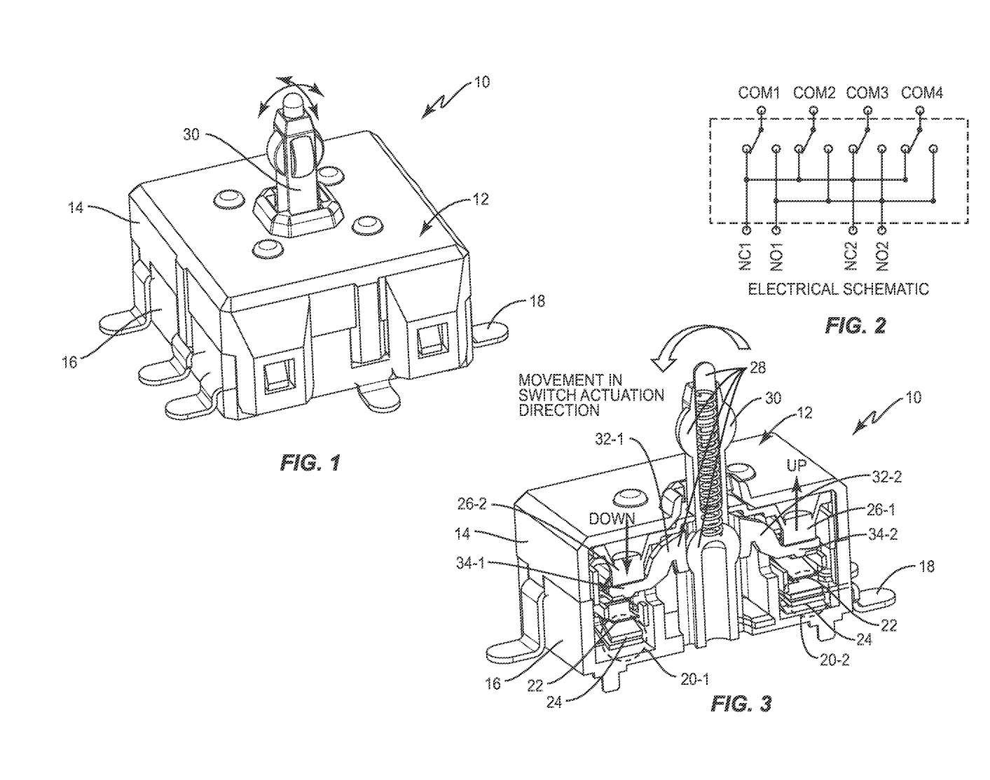

FIG. 1 is a perspective view of one embodiment of a witch cell 10 that includes a housing assembly 12 that includes a cover 14 and a housing 16. The switch cell 10 further includes one or more leads or terminals 18, for electrical connections.

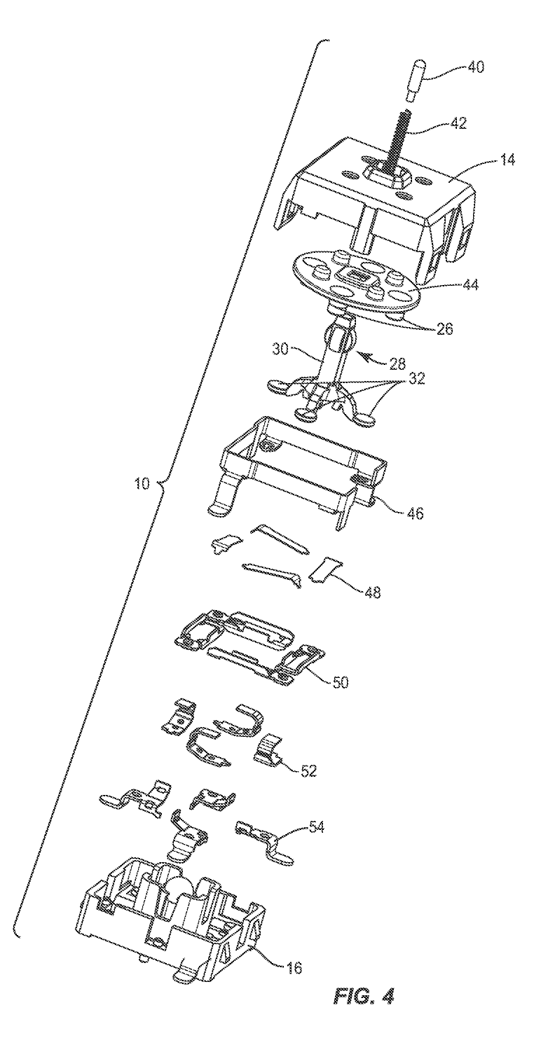

FIG. 2 is an example, non-limiting electrical schematic of the switch cell 10. According FIG. 2, the switch cell 10 provides switches four connections, such as for up/down and fore/aft motors in a powerseat.

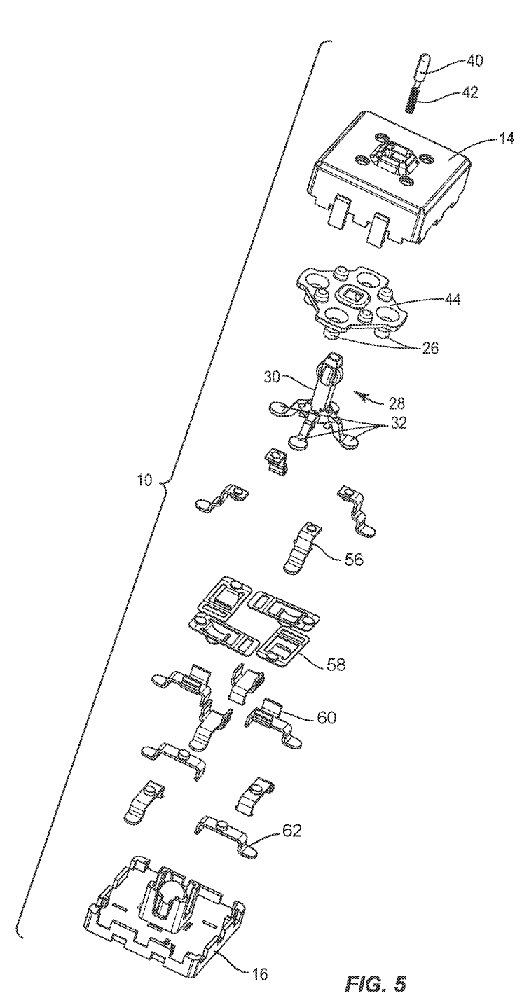

FIG. 3 depicts a cutaway view of the switch cell 10. One sees that the switch cell 10 includes at least one switch 20 comprising first and second electrical contacts 22 and 24. The electrical contacts 22 and 24 are configured as a contact pair and are supported within the housing assembly 12. In particular, in the illustration, two such switches 20-1 and 20-2 are visible, and each has first and second contacts 22 and 24. It will be understood that, with respect to the example schematic of FIG. 2, the switch cell 10 would also have switches 20-3 and 20-4 (not illustrated). Unless needed for clarity, the reference number “20” without any suffix is used to refer to any given switch or switches.

FIG. 3 further illustrates that each switch 20 has a corresponding non-electrical tactile feedback pad 26 that is separate from the switch 20 and is supported within the housing assembly 12. in the illustration, the switch 20-1 is associated with a tactile feedback pad 26-1 and the switch 20-2 is associated with a tactile feedback pad 26-2. For a given switch 20, the corresponding tactile feedback pad 26 has a configured compression force profile, for imparting a desired tactile curve associated with actuation of the switch 20.

In the illustrated switch cell configuration, actuation of the switches 20 within the housing assembly 12 is accomplished via an actuator assembly 28 that is movably supported within the housing assembly 12. For example, the actuator assembly 28 may be configured as a joystick-like actuator that provides multi-axis actuation.

Here, the actuator assembly 28 comprises a first member 30 that extends to an exterior of the housing assembly 12 and is coupled to one or more interior members 32. The interior member(s) 32 are configured to actuate one or more of the switches 20 supported within the housing assembly 12 while simultaneously compressing the corresponding tactile feedback pad(s) 26 when the first member 30 is moved in a defined switch actuation direction. For example, if the first member 30 is moved or tilted towards the switch 20-1, the end 34-1 of a member 32-1 moves downward to actuate the switch 20-1 and, at the same time, the end 34-2 of the member 32-2 moves upward into compressive engagement with the tactile feedback pad 26-1. In other words, actuating the switch 20-1 compresses the tactile feedback pad 26-1. The same is true with respect to actuation of the switch 20-2 and the corresponding tactile feedback pad 26-2.

Consequently, while each switch 20 within the housing assembly 12 may contribute to a portion of the overall tactile feel experienced by a user when actuating the switch 20 via the actuator assembly 28, the overall tactile feel is established by the compression force profile of the tactile feedback pad 26 corresponding) the switch 20. That is, the tactile feedback pad 26 can be used to establish or tune the tactile feel, and a switch cell 10 that is otherwise the same as another switch cell 10 of the same design can exhibit markedly different tactile response curves simply by installing different tactile feedback pad(s) 26 in it.

Thus, in at least one embodiment, a switch cell 10 as contemplated herein includes first and second switches 20-1 and 20-2. Correspondingly, the one or more interior members of the switch actuation assembly 28 comprise opposing first and second actuator arms 32-1 and 32-2 that are configured to move in unison in opposing directions. According to the depicted configuration, moving the first member 30 in a first switch actuation direction causes the first actuator arm 32-1 to actuate the first switch 20-1 while simultaneously causing the second actuator arm 32-2 to compress a first non-electrical tactile feedback pad 26-1. Conversely, moving the first member 30 in an opposite, second switch actuation direction causes the second actuator arm 32-2 to actuate the second switch 20-2 while simultaneously causing the first actuator arm 32-1 to compress a second non-electrical tactile feedback pad 26-2.

Notably, the first and second electrical contacts 22, 24 of each switch 20 may be a pair of metallic contacts adapted for switching currents in excess of one Ampere. This feature makes the switch cell 10 well suited for high-current applications, which stands as an additional advantage on top of the advantageous ability to tailor the tactile feel of the switch cell 10 via tactile feedback pad(s) 26, which may be made removable or at least interchangeable between switch cells 10 of the same design.

In at least some embodiments, the one or more interior members 32 are configured in a rocker arm arrangement. The interior members 32 of the rocker arm arrangement include at least the first actuator arm 32-1 extending within the interior of the housing assembly 12 and an opposing second actuator arm 32-2 extending within the interior of the housing assembly 12. The first actuator arm 32-1 has a first end 34-1 positioned between a first switch 20-1 and a second non-electrical tactile feedback pad 26-2. The second actuator arm 32-2 has a second end 34-2 positioned between a second switch 20-2 and a first non-electrical tactile feedback pad 26-1.

Here, “between” can be understood as the rocker arm end 34-1 (or 34-2) having a tactile feedback pad 26-1 (or 26-2) above it and having an electrical contact 22 or 24 for the switch 20-1 (or 20-2) below it. Of course, the terms “above” and “below” are not intended to be limiting and are used merely to establish a convenient frame of reference with respect to the switch orientation seen in FIGS. 1 and 3, for example. With this arrangement, tilting the first member 30 in a first direction causes the first end 34-1 to actuate the first switch 20-1 and causes the second end 34-2 to engage the first tactile feedback pad 26-1. Tilting the first member 30 in an opposite second direction causes the second end 34-2 to actuate the second switch 20-2 and causes the first end 34-1 to engage the second tactile feedback pad 26-2.

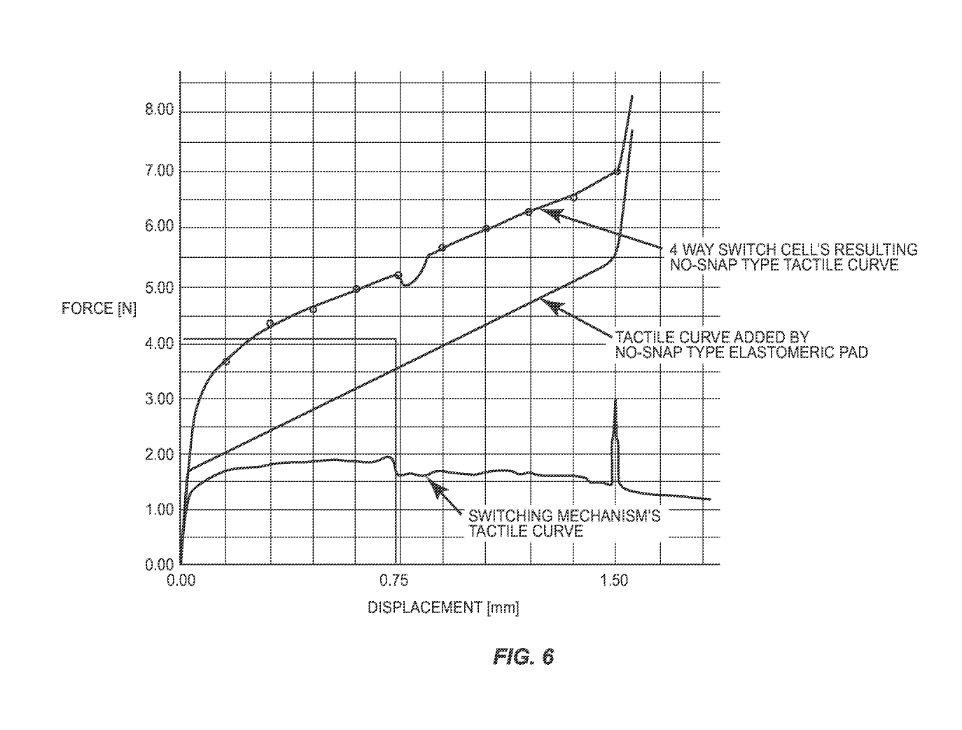

FIG. 4 illustrates an exploded view of a first design of a 4-way switch cell 10. The actuator assembly 28 includes an anti-rattle plunger 40 on a spring 42 that inserts into or otherwise engages with the first member 30.

One also sees that a member 44 formed here as a disk includes or carries a number of tactile feedback pads 26, e.g., one tactile feedback pad 26 for each switch 20 included in the switch cell 10. The four switches 20 implemented in this embodiment are formed using a common normally-closed terminal 46, a set of four movable springs 48, a set of four movable arms 50 with contact pills, a set of four hooks 52, and a set of four contact terminals 54.

FIG. 5 illustrates a similar arrangement, except that the switches 20 are formed using a set of four normally-closed terminals 56, a set of four movable arms 58 with electrical contact pills, a set of common terminals 60, and a set of normally-open terminals 62.

FIGS. 4 and 5 can, therefore, be understood as depicting example details for implementing non-electrical tactile feedback pads 26 within the switch cell 10. In particular, a tactile feedback pad 26 may be implemented as part of a member 44 that is removably supported within the housing assembly 12 of the switch cell 10.

The member 44 comprises, for example, a disk made of elastomeric or other resilient material. In one such embodiment, each tactile feedback pad 26 comprises a collapsible dome formed within the resilient member 44. In another embodiment, each tactile feedback pad 26 comprises a thickened section of the member 44. The tactile feedback pad 26 thus operates as a soft stop for limiting the travel of the actuator assembly 28.

Implementing the tactile feedback pads 26 via the member 44 allows a switch cell manufacturer to build or reconfigure a given switch cell 10 with a particular tactile feedback response, or with a particular set of tactile feedback responses for multiple included switches 20, simply by selecting or changing the member 44. The same switch cell 10 can be imbued with different tactile feedback responses merely by selecting the appropriate member 44. Moreover, it should be understood that in cases where the member 44 carries more than one tactile feedback pad 26, two or more of those tactile feedback pads 26 may have different compression force profiles i.e., they may provide different tactile feel response curves.

Still further, any one or more of the tactile feedback pads 26 carried by the member 44 may have a “snap” actuation or a non-snap actuation, where a snap actuation has a markedly non-linear compression force profile that results in higher initial resistance, followed by sharp or step-change lowering of resistance as the tactile feedback pad 26 is compressed beyond a certain point or amount. In this regard, the tactile feedback pads 26 can be formed as domes or pillows in the member 44, or merely as thickened areas of the member 44, or the entire member 44 may be formed such that it has a broad, possibly continuous area or region where any point is suitable for use as a tactile feedback pad 26.

Regardless of the particulars by which the tactile feedback pad(s) 26 are implemented in the member 44, in one or more embodiments the member 44 is configured to isolate a lower interior portion of the housing assembly 12, when it is installed within the housing assembly 12. The member 44 thereby provides at least one of sound isolation and water resistance for the switch(es) 20 positioned within the lower interior portion of the housing assembly 12. Thus, as a further advantage in some embodiments, the member 44 not only serves as a carrier for the tactile feedback pad(s) 26, it reduces switching sounds and provides fluid and/or contamination resistance for the switches) 20. Correspondingly, in at least some embodiments, the switch cell 10 is configured such that the tactile feedback pad 26 is installable in and removable from the housing assembly 12 independent of the switch(es) 20.

The overall tactile curve exhibited by a switch 20 in the switch cell 10 can be understood as the sum of two tactile curves: the tactile curve of each of the switch 20, and the tactile curve of the corresponding tactile feedback pad 20. The curve associated with tactile feedback pad 26 may, however, be dominant.

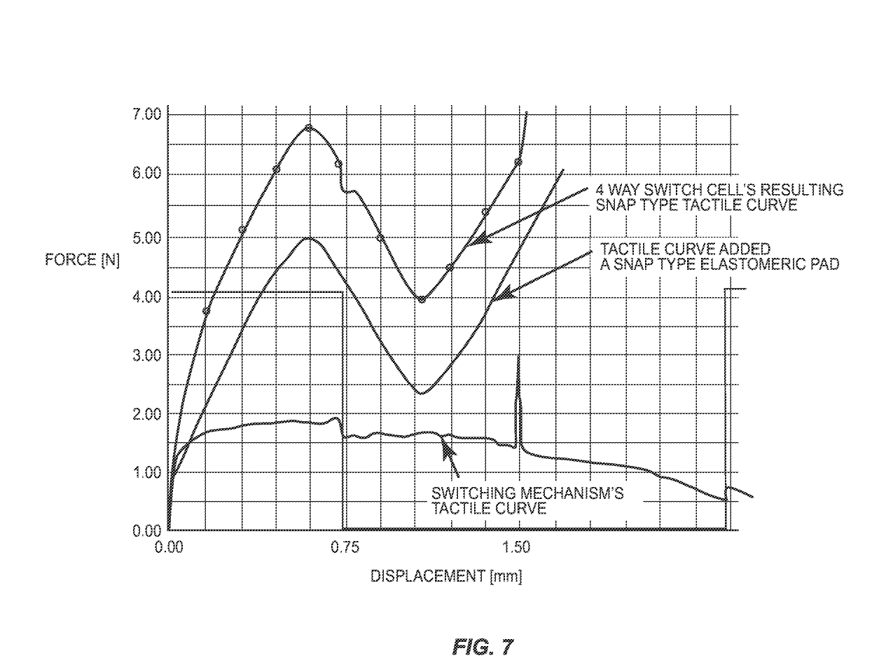

FIGS. 6 and 7 are two examples of switch cell tactile curves built using a “non-snap” type and a “snap” type ePad, respectively. FIG. 6 shows three non-snap tactile curves on a graph. The lower tactile curve corresponds to the switch 20 and can be understood as representing its “native” or inherent tactile response curve. The middle tactile curve represents the tactile response curve of the tactile feedback pad 26 used in conjunction with the switch 20. The upper tactile curve shows the resulting sum of tactile response curves for the switch 20 and the tactile feedback pad 26 and thus represents the tactile response experienced by a user when actuating the switch 20.

Note that in this example, the 0.75 mm mark represents the point of contact closure for the switch 20, and the 1.50 mm mark represents the hard stop limit of the switch 20. One sees that the tactile response curve of the tactile feedback pad 26 dramatically softens or otherwise masks the hard stop exhibited by the bare switch 20. In other words, one of the several advantages gained by use of the tactile feedback pad 26 is that it imparts a “soft stop” characteristic to the overall switch cell 10, as the user encounters the travel limit of the switch 20.

FIG. 7 illustrates a similar scenario, except that the tactile feedback pad 26 at issue is configured with a snap-type response. Thus, the switch cell 10 can be configured with snap-type tactile feedback pads 26, or with non-snap-type tactile feedback pads 26, or with a mix of snap-type and non-snap-type tactile feedback pads 26.

Further, the actuator knobs or appendages that are typically fastened to the first member 30 of the switch actuator assembly 28 in a finished installation may be asymmetrical and may include shapes other than squares, cylinders or spheres, Accordingly, the tactile feedback pad 26 may be designed with different tactile curves corresponding to different actuator movement directions, in order to balance the feel experienced by the user for the different actuation directions, or to impart distinctively different tactile feel to different actuation directions and/or different adjustment functions.

Notably, modifications and other embodiments of the disclosed inventions) will come to mind to one skilled in the art having the benefit of the teachings presented in the foregoing descriptions and the associated drawings. For example, a sliding rather than a rocking actuator may be used in the switch cell 10, with the sliding actuator sliding into engagement with one or more tactile feedback pads 26 when a switch 20 is actuated.

Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A switch cell comprising:
a housing assembly;
a switch comprising first and second electrical contacts configured as a contact pair and supported within the housing assembly;
a non-electrical tactile feedback pad separate from the switch and supported within the housing assembly, the tactile feedback pad having a configured compression force profile for imparting a desired tactile curve associated with actuation of the switch via an actuator assembly that is movably supported within the housing assembly; and
the actuator assembly comprising a first member extending to an exterior of the housing assembly and coupled to one or more interior members that are configured to actuate the switch while simultaneously compressing the tactile feedback pad, when the first member is moved in a defined switch actuation direction.

2. The switch cell of claim 1, wherein the switch cell includes first and second switches and wherein the one or more interior members of the switch actuation assembly comprise opposing first and second actuator arms configured to move in unison in opposing directions, such that moving the first member in a first switch actuation direction causes the first actuator arm to actuate the first switch while simultaneously causing the second actuator arm to compress a first non-electrical tactile feedback pad, and such that moving the first member in an opposite, second switch actuation direction causes the second actuator arm to actuate the second switch while simultaneously causing the first actuator arm to compress a second non-electrical tactile feedback pad.

3. The switch cell of claim 1, wherein the desired tactile curve associated with actuation of the switch via the actuator assembly is a function of a first tactile curve associated with the switch and a second tactile curve associated with the tactile feedback pad, and wherein the configured compression force profile of the tactile feedback pad corresponds to a difference between the desired tactile curve and the first tactile curve.

4. The switch cell of claim 1, wherein the tactile feedback pad comprises part of a resilient member that is removably supported within the housing assembly of the switch cell.

5. The switch cell of claim 4, wherein the tactile feedback pad comprises a collapsible dome formed within the resilient member.

6. The switch cell of claim 4, wherein the tactile feedback pad comprises a thickened section of the resilient member.

7. The switch cell of claim 4, wherein the resilient member is configured to isolate a lower interior portion of the housing assembly when installed within the housing assembly and thereby provide at least one of sound isolation and water resistance for the switch positioned within the lower interior portion of the housing assembly.

8. The switch cell of claim 1, wherein the tactile feedback pad is operative as a soft stop for limiting the travel of the actuator assembly.

9. The switch cell of claim 1, wherein the switch cell is configured such that the tactile feedback pad is installable in and removable from the housing assembly independent of the switch.

10. The switch cell of claim 1, wherein the first and second electrical contacts of the switch comprise a pair of metallic contacts adapted for switching currents in excess of one Amperes.

11. The switch cell of claim 1, wherein the one or more interior members comprise a rocker arm arrangement having a first actuator arm extending within the interior of the housing assembly and an opposing second actuator arm extending within the interior of the housing assembly, the first actuator arm having a first end positioned between a first switch and a second non-electrical tactile feedback pad, the second actuator arm having a second end positioned between a second switch and a first non-electrical tactile feedback pad, and wherein tilting the first member in a first direction causes the first end to actuate the first switch and causes the second end to engage the first tactile feedback pad, and tilting the first member in an opposite second direction causes the second end to actuate the second switch and causes the first end to engage the second tactile feedback pad.
